(19) United States
(12) Patent Application Publication
(10) Pub. No.: US 2023/0038741 A1
(43) Pub. Date: Feb. 9, 2023

(54) ANODE FOR SECONDARY BATTERY AND SECONDARY BATTERY INCLUDING THE SAME

(71) Applicant: SK ON CO., LTD., Seoul (KR)

(72) Inventors: Hyo Mi KIM, Daejeon (KR); Moon Sung KIM, Daejeon (KR); Sang Baek RYU, Daejeon (KR); Seung Hyun YOOK, Daejeon (KR); Hwan Ho JANG, Daejeon (KR); Jun Hee HAN, Daejeon (KR)

(21) Appl. No.: 17/874,809

(22) Filed: Jul. 27, 2022

(30) Foreign Application Priority Data
Jul. 27, 2021 (KR) 10-2021-0098225

(51) Int. Cl. H01M 4/36; H01M 4/48; H01M 4/587; H01M 10/0525; H01M 4/133; H01M 10/0585

(52) U.S. Cl. CPC H01M 4/366; H01M 4/483; H01M 4/587; H01M 10/0525; H01M 4/133; H01M 10/0585; H01M 2004/027

(57) ABSTRACT

An anode for a secondary battery including an anode active material and a secondary battery including the anode and having improved stability and reduced resistance are disclosed. In an aspect, the anode active material includes a silicon-based active material having a specific surface area (BET) in a range from 0.5 m²/g to 5 m²/g, a first carbon-based active material having an average particle diameter (D50) in a range from 1 μm to 4 μm, and a second carbon-based active material having an average particle diameter greater than that of the first carbon-based active material.

### PRIORITY CLAIM AND CROSS-REFERENCE TO RELATED APPLICATION

This application claims priority to Korean Patent Application No. 10-2021-0098225 filed at the Korean Intellectual Property Office (KIPO) on Jul. 27, 2021, the entire disclosure of which is incorporated herein by reference.

### TECHNICAL FIELD

The disclosure of this patent document relates to an anode for a secondary battery and a secondary battery including the same.

### BACKGROUND

The rapid growth of electric vehicles and portable devices, such as camcorders, mobile phones, and laptop computers, has brought increasing demands for secondary batteries, which can be charged and discharged repeatedly. Examples of the secondary battery includes lithium secondary batteries, nickel-cadmium batteries, and nickel-hydrogen batteries. The lithium secondary batteries are now widely used due to high operational voltage and energy density per unit weight, a high charging rate, a compact dimension, etc.

A lithium secondary battery may include an electrode assembly including a cathode, an anode and a separation layer (separator), and an electrolyte immersing the electrode assembly. The lithium secondary battery may further include an outer case having, e.g., a pouch shape.

For example, the anode may include a carbon-based active material or silicon-based active material particles as an anode active material. When the battery is repeatedly charged and discharged, a mechanical and chemical damage such as particle cracks may be caused, and a poor contact between active material particles, a short-circuit, etc., may also occur.

If a composition and a structure of the anode active material are changed to improve stability of the active material particles, a conductivity may be degraded and a power of the secondary battery may be deteriorated. Thus, developments of the anode active material capable of enhancing life-span stability and power/capacity properties are needed.

In order to address such issues, some lithium secondary battery designs include an electrode assembly for a lithium secondary battery.

### SUMMARY

This patent document discloses technical features and examples for an anode for a secondary battery having improved structural stability and electrical property.

According to an aspect of the disclosed technology, there is provided a secondary battery including an anode with improved structural stability and electrical property.

An anode for a secondary battery comprising an anode active material is provided. The anode active material includes a silicon-based active material having a specific surface area (e.g., a surface area measured based on adsorption measurements such as a Brunaucr-Emmett-Teller (BET) method) in a range from 0.5 m²/g to 5 m²/g, a first carbon-based active material having an average particle diameter (D50) in a range from 1 μm to 4 μm, and a second carbon-based active material having an average particle diameter greater than that of the first carbon-based active material.

In some embodiments, an average particle diameter of the second carbon-based active material may be in a range from 8 μm to 20 μm.

In some embodiments, I(110)/I(002) of the first carbon-based active material measured by an X-ray diffraction analysis (XRD) may be in a range from 0.04 to 0.10.

In some embodiments, a crystallite size (Lc) in a C-axis direction of the first carbon-based active material measured by an X-ray diffraction analysis (XRD) may be less than 30 nm.

In some embodiments, the first carbon-based active material may include hard carbon.

In some embodiments, the second carbon-based active material may include natural graphite, artificial graphite or a mixture of the natural graphite and the artificial graphite.

In some embodiments, the silicon-based active material may include SiOx (0≤x≤2).

In some embodiments, the silicon-based active material may have a true density in a range from 2.0 g/cc to 2.6 g/cc.

In some embodiments, a content of the first carbon-based active material may be in a range from 0.1 wt % to 2 wt % based on a total weight of the anode active material.

In some embodiments, a content of the silicon-based active material may be in a range from 5 wt % to 20 wt % based on a total weight of the anode active material.

In some embodiments, the anode may include an anode electrode current collector, and an anode active material layer including the anode active material. The anode active material layer may include a first anode active material layer formed on the anode current collector, and a second anode active material layer formed on the first anode active material layer.

In some embodiments, a content of the silicon-based active material included in the first anode active material layer may be in a range from 6 wt % or less based on a total weight of the first anode active material layer, and a content of the silicon-based active material included in the second anode active material layer may be equal to or greater than 8 wt % and less than 40 wt % based on a total weight of the second anode active material layer.

In some embodiments, a content of the first carbon-based active material included in the first anode active material layer may be less than 2 wt % based on the total weight of the first anode active material layer, and a content of the first carbon-based active material included in the second anode active material layer may be equal to or greater than 2 wt % and less than 4 wt % based on the total weight of the second anode active material layer.

In some embodiments, a ratio of a weight of the second anode active material layer relative to a weight of the first anode active material layer may be in a range from 1 to 4.

A secondary battery includes the anode for a lithium secondary battery according to embodiments as described above and a cathode facing the anode.

According to exemplary embodiments, an anode for a secondary battery may include a silicon-based active material having a specific surface area in a predetermined range and a carbon-based active material having an average particle diameter in a predetermined range. The silicon-based active material having the specific surface area within the predetermined range may be used so that the anode for a secondary battery having high energy density and discharge capacity may be provided.

The carbon-based active material having the average particle diameter within the predetermined range may be used, so that electron/ion transfer paths may be formed in the anode for a secondary battery. Accordingly, high capacity and rate properties of the secondary battery may be achieved.

The anode for a secondary battery may include hard carbon as a carbon-based active material. Hard carbon may react in a relatively high potential band compared to that of graphite, so that expansion/contraction and degradation of the silicon-based active material may be prevented, and a poor contact between active materials and generation of a short circuit may be prevented.

### BRIEF DESCRIPTION OF THE DRAWINGS

FIG. 1 is a schematic plan view illustrating a secondary battery in accordance with exemplary embodiments.

FIG. 2 is a schematic cross-sectional view illustrating an electrode assembly in accordance with exemplary embodiments.

### DETAILED DESCRIPTION OF THE EMBODIMENTS

According to exemplary embodiments of the disclosed technology, an anode for a secondary battery that includes an anode active material including a silicon-based active material and a carbon-based active material is provided. Further, a secondary battery including the anode is provided.

<Anode for Secondary Battery>

An anode for a secondary battery may include an anode active material including a silicon-based active material, a first carbon-based active material and a second carbon-based active material. For example, the anode active material may be a mixture in which the silicon-based active material, the first carbon-based active material and the second carbon-based active material are uniformly mixed/dispersed. In some implementations, the silicon-based active material may indicate an active material that includes silicon. In some implementations, the carbon-based active material may indicate an active material that includes carbon.

In exemplary embodiments, a specific surface area of the silicon-based active material may be in a range from 0.5 m²/g to 5 m²/g, for example, in a range from 1 m²/g to 5 m²/g. The specific surface area may be measured by suitable methods, including, e.g., measurements based on adsorption such as a Brunaucr-Emmett-Teller (BET) method.

If the specific surface area of the silicon-based active material is less than 0.5 m²/g, a contact area of the active material may be decreased, thereby deteriorating a charge/discharge capacity of the battery. If the specific surface area of the silicon-based active material exceeds 5 m²/g, life-span properties of the battery may be deteriorated.

For example, the silicon-based active material may be a silicon-based active material having a non-porous structure. When an active material has a porous structure, reactivity with moisture and oxygen in air or an electrolyte may be increased due to a high specific surface area.

Further, collapse/regeneration of a solid electrolyte interphase (SEI) layer on a surface of the active material may be repeated due to volume expansion and contraction of the silicon-based active material to degrade life-span properties of the secondary battery. Additionally, the electrolyte may be depleted by repeated destruction and formation of the SEI layer according to the charging/discharging process, and the capacity of the battery may de decreased.

In the anode according to exemplary embodiments, the silicon-based active material may have the non-porous structure. Accordingly, the silicon-based active material may have a low specific surface area, and power and life-span properties of the battery may be improved.

In some embodiments, a true density of the silicon-based active material may be about 2.0 g/cc or more. In one example, the true density of the silicon-based active material may be in a range from about 2.0 g/cc to 2.6 g/cc. In another example, the true density of the silicon-based active material may be in a range from about 2.1 g/cc to 2.5 g/cc.

If the true density of the silicon-based active material is less than about 2.0 g/cc, the silicon-based active material may have a porous structure and a packing density may be de decreased. For example, if pores are present in particles, a true density of silicon particles may be lowered to less than 2 g/cc when compared to a true density of pure silicon particles.

In exemplary embodiments, the true density of the silicon-based active material may be 2 g/cc or more, so that voids may not exist in the particles of the silicon-based active material. Accordingly, an energy density of the anode active material may be improved.

Additionally, the silicon-based active material may have a high true density, so that packing properties of a composition for the anode may be improved, and potential flatness, initial capacity and charge/discharge reversibility may be improved.

In some embodiments, the silicon-based active material may include silicon (Si), a silicon oxide (SiOx, 0<x<2), a silicon oxide (SiOx, 0<x<2) containing a lithium compound, a silicon-metal alloy or a silicon-carbon composite (Si—C). In some embodiments, the silicon-based active material may include a combination of two or more of silicon (Si), a silicon oxide (SiOx, 0<x<2), a silicon oxide (SiOx, 0<x<2) containing a lithium compound, a silicon-metal alloy or a silicon-carbon composite (Si—C).

The SiOx containing the lithium compound may be a SiOx containing lithium silicate. Lithium silicate may be present in at least a portion of SiOx (0≤x≤2) particles, and may be present, e.g., at an inside and/or on the surface of the SiOx (0≤x≤2) particles. The lithium silicate may include Li₂SiO₃, Li₂Si₂O₅, Li₄SiO₄, Li₄Si₃O₈, etc.

The silicon-carbon composite may be silicon carbide (SiC) formed by mechanically combining silicon and carbon.

In some embodiments of the disclosed technology, the silicon-based active material may include the silicon oxide (SiOx, 0<x<2). In this case, the capacity and stability of the secondary battery may be further improved.

In some embodiments, a content of the silicon-based active material may be in a range from 5 weight percent (wt %) to 20 wt % based on a total weight of the anode active material. If the content of the silicon-based active material exceeds 20 wt %, a short circuit in the battery may occur due to volume expansion during charging and discharging. If the content of the silicon-based active material is less than 5 wt %, an initial efficiency may be lowered due to a relatively excess amount of the carbon-based active material.

In some embodiments of the disclosed technology, the content of the silicon-based active material may be in a range from 5 wt % to 15 wt % based on the total weight of the anode active material. In the above range, a short circuit and a poor contact of the active material may be prevented while maintaining high-capacity properties of the battery.

In some embodiments, an average particle diameter (D50) of the silicon-based active material may be in a range from 1 μm to 20 μm, for example, in a range from 4 μm to 15 μm. The average particle diameter (D50) refers to a particle diameter at 50% of a volume fraction in a volume cumulative particle size distribution.

A material formed of material particles with different sizes may be indicated by an average particle diameter DX, where X represents a percentage of particles in volume in the material with particle diameters not greater than DX, or in other words, DX indicates a diameter of a particle corresponding to a volume fraction of X % in an accumulation from the smallest particles to largest particles. Consider an example of D50 for X=50, a volume average particle diameter (D50) at 10 μm represents that there are 50% of the particles in volume in this material with particle diameters less than or equal to 10 μm. In other words, a volume average particle diameter (D50) refers to a particle size at 50% of a volume fraction of all particles in the material in an accumulation from the smallest particle to the largest particle using a particle size distribution.

If the average particle diameter of the silicon-based active material is less than 1 μm, the initial efficiency may be reduced, and dispersibility in an active material slurry may be deteriorated. If the average particle diameter of the silicon-based active material is greater than 20 μm, expansion/contraction of the active material may be increased during repeated charging and discharging, and life-span properties of the secondary battery may be degraded.

In some embodiments of the disclosed technology, the average particle diameter (D50) of the first carbon-based active material may be in a range from 1 μm to 4 μm, for example, in a range from 2 μm to 4 μm. As the first carbon-based active material has an average particle diameter of 4 μm or less, a conductive path may be formed in the active material, and thus the power and life-span properties of the secondary battery may be improved.

For example, the first carbon-based active material may have a relatively small particle diameter to function as a conductive material in the active material. Accordingly, a poor contact between active materials and generation of a short circuit may be prevented, and power of the battery may be improved.

If the average particle diameter of the first carbon-based active material is greater than 4 μm, the first carbon-based active material may not function as a conductive material. In this case, the energy density of the battery may be reduced due to an excessive amount of the conductive material.

According to exemplary embodiments, the first carbon-based active material has an average particle diameter of 4 μm or less so that the power and life-span properties of the secondary battery may be improved even if the content of the conductive material is small.

In some embodiments, I(110)/I(002) of the first carbon-based active material measured by an X-ray diffraction analysis (XRD) may be in a range from 0.04 to 0.10. For example, I(110)/I(002) may be an area ratio calculated by integrating the measured peaks (e.g., intensity peak) obtained by measuring the (110) plane and the (002) plane of the first carbon-based active material by XRD.

In the above range, the first carbon-based active material may have low crystallinity, and thus the reaction potential of the first carbon-based active material may be increased. In this case, the first carbon-based active material reacts in a high potential band in which the silicon-based active material reacts so that degradation of the silicon-based active material may be prevented. Accordingly, the secondary battery may have high energy density and high efficiency.

In some embodiments, a crystallite size (Lc) in a C-axis direction of the first carbon-based active material measured by an XRD may be less than 30 nm, for example, may be equal to or greater than 1 nm and less than 30 nm. In the above range, crystallinity of the first carbon-based active material may be lowered, and the power and life-span properties of the secondary battery may be improved. In some implementations, the C-axis may indicate a vertically oriented crystal axis.

In some embodiments, the first carbon-based active material may include an amorphous carbon-based active material such as hard carbon, soft carbon, a calcined coke, or a mesophase pitch carbide. In some embodiments of the disclosed technology, the first carbon-based active material may include hard carbon.

Hard carbon has a higher reaction potential than that of graphite. Thus, hard carbon may participate in a reaction even in a low state of charge (SOC) region where the silicon-based active material mainly reacts to prevent degradation of the silicon-based active material due to charging and discharging. Accordingly, life-span degradation of the battery due to an expansion of the silicon-based active material and an electrode short circuit may be prevented.

For example, the silicon-based active material may react in the low SOC region to cause volume expansion and contraction of the silicon-based active material. In this case, a large amount of an SEI layer may be formed on the surface of the active material, and thus a distance between the particles may be increased and an electrical contact between the particles may be weakened, thereby causing a lithium trap. The lithium trap may refer to a phenomenon in which lithium inserted into the active material does not move due to deterioration of the contact between the active material particles.

In some embodiments, the first carbon-based active material may include hard carbon, so that degradation of the silicon-based active material may be prevented, and the life-span and capacity of the battery may be improved.

In some embodiments, a content of the first carbon-based active material may be in a range from 0.1 wt % to 2 wt %, for example, from 1 wt % to 2 wt % based on the total weight of the anode active material.

If the content of the first carbon-based active material is less than 0.1 wt %, a conductive path may not be sufficiently formed in the anode, and the silicon-based active material may be degraded by repeated charging and discharging.

If the content of the first carbon-based active material exceeds 2 wt %, the energy density of the battery may be decreased due to a low discharge capacity of the first carbon-based active material, and a specific surface area of the anode active material may increase, thereby increasing a side reaction with the electrolyte. Additionally, thermal and chemical stability of the anode active material and high-temperature properties of the secondary battery may be lowered due to the low crystallinity of the first carbon-based active material.

The second carbon-based active material may have a larger average particle diameter than that of the first carbon-based active material. Different types of carbon-based active materials having different average particle diameters may be included, so that packing properties of the anode active material may be improved.

For example, an average particle diameter of the second carbon-based active material may be 8 μm to 20 μm. Within the above range, the side reaction between the active material and the electrolyte may be reduced, and mechanical and structural stability of the anode active material may be improved.

In some embodiments, the second carbon-based active material may include a crystalline carbon-based active material, for example, natural graphite, artificial graphite or a mixture of the natural graphite and the artificial graphite. Natural graphite and artificial graphite may have higher discharge capacity and greater life-span properties compared to those from amorphous carbon-based active materials such as hard carbon, and thus may be suitable for high energy density batteries. Further, natural graphite and artificial graphite having high thermal and chemical stability may be included, so that high-temperature storage and high-temperature life-span properties of the battery may also be improved.

In some embodiments of the disclosed technology, the second carbon-based active material may include artificial graphite. Artificial graphite may provide a lower capacity than that of natural graphite, but may have relatively high chemical and thermal stability to provide enhanced life-span and high temperature storage properties. For example, when natural graphite is solely used, a higher capacity than that from artificial graphite may be provided, but a porosity in the active material may be decreased due to a particle compression during a pressing process to degrade resistance and life-span properties of the battery.

In some embodiments, the second carbon-based active material may be included in a residual amount in the anode active material. The term “residual amount” may refer to a variable amount that may be changed according to an addition of other ingredients. For example, the second carbon-based active material may be included in the anode active material in an remaining amount except for the silicon-based active material and the first carbon-based active material.

In some embodiments of the disclosed technology, the content of the second carbon-based active material may be in a range from 79 wt % to 94 wt % based on the total weight of the anode active material. If the content of the second carbon-based active material is less than 79 wt %, the short circuit in the electrode may occur and the life-span of the battery may be deteriorated. If the content of the second carbon-based active material exceeds 94 wt %, the content of the silicon-based active material is reduced, and thus a capacity of the battery may be reduced.

In some embodiments, the anode composition may further include other active materials within a range that does not impair the performance of the silicon-based active material, the first carbon-based active material and the second carbon-based active material.

<Secondary Battery>

Hereinafter, a secondary battery according to embodiments of the disclosed technology will be described in more detail with reference to the accompanying drawings. However, those skilled in the art will appreciate that such embodiments described with reference to the accompanying drawings are provided to further understand the spirit of the disclosed technology and do not limit subject matters to be protected as disclosed in the detailed description and appended claims.

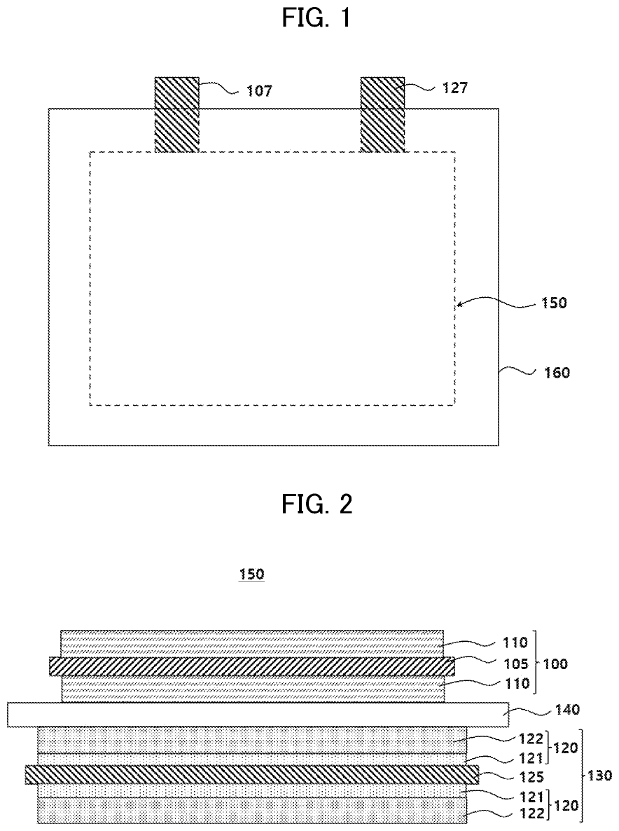

FIGS. 1 and 2 are a schematic plan view and a schematic cross-sectional view illustrating a secondary battery in accordance with exemplary embodiments. For example, FIG. 2 is a cross-sectional view of an electrode assembly 150 in FIG. 1.

For convenience of descriptions, illustration of a cathode and an anode is omitted in FIG. 1.

Referring to FIGS. 1 and 2, the secondary battery may serve as a lithium secondary battery. In exemplary embodiments, the secondary battery may include the electrode assembly 150 and a case 160 accommodating the electrode assembly 150. The electrode assembly 150 may include a cathode 100, an anode 130 and a separation layer 140.

The cathode 100 may include a cathode current collector 105 and a cathode active material layer 110 formed on at least one surface of the cathode current collector 105. In exemplary embodiments, the cathode active material layer 110 may be formed on both surfaces (e.g., upper and lower surfaces) of the cathode current collector 105. For example, the cathode active material layer 110 may be coated on each of the upper and lower surfaces of the cathode current collector 105, and may be directly coated on the surface of the cathode current collector 105.

The cathode current collector 105 may include stainless-steel, nickel, aluminum, titanium, copper or an alloy of two or more of stainless-steel, nickel, aluminum, titanium, copper. In some embodiments of the disclosed technology, aluminum or an alloy including aluminum may be used.

The cathode active material layer 110 may include a lithium metal oxide as a cathode active material. In exemplary embodiments, the cathode active material may include a lithium (Li)-nickel (Ni)-based oxide.

In some embodiments, the lithium metal oxide included in the cathode active material layer 110 may be represented by Chemical Formula 1 below.

Li₁₊ₐNi_{1-(x+y)}CₒₓM_{y}O₂ [Chemical Formula 1]

In the Chemical Formula 1 above, −0.05≤a≤0.15, 0.01≤x≤0.2, 0≤y≤0.2, and M may include at least one element selected from Mn, Mg, Sr, Ba, B, Al, Si, Ti, Zr and W. In an embodiment, 0.01≤x≤0.20, 0.01≤y≤0.15 in Chemical Formula 1.

In some embodiments of the disclosed technology, in Chemical Formula 1, M may be manganese (Mn). In this case, nickel-cobalt-manganese (NCM)-based lithium oxide may be used as the cathode active material.

For example, nickel (Ni) may serve as a metal related to a capacity of a lithium secondary battery. As the content of nickel increases, capacity of the lithium secondary battery may be improved. However, if the content of nickel is excessively increased, life-span may be decreased, and mechanical and electrical stability may be degraded.

For example, cobalt (Co) may serve as a metal related to conductivity or resistance of the lithium secondary battery. In an embodiment, M may include manganese (Mn), and Mn may serve as a metal related to mechanical and electrical stability of the lithium secondary battery.

Power, low resistance and life-span stability may be improved together from the cathode active material layer 110 by the above-described interaction between nickel, cobalt and manganese.

For example, a slurry may be prepared by mixing and stirring the cathode active material with a binder, a conductive material and/or a dispersive agent in a solvent. The slurry may be coated on the cathode current collector 105, and then dried and pressed to form the cathode active material layer 110.

The binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

For example, a PVDF-based binder may be used as a cathode binder. In this case, an amount of the binder for forming the cathode active material layer 110 may be reduced, and an amount of the cathode active material or lithium metal oxide particles may be relatively increased. Thus, capacity and power of the lithium secondary battery may be further improved.

The conductive material may be added to facilitate electron mobility between active material particles. For example, the conductive material may include a carbon-based material such as graphite, carbon black, graphene, a single walled carbon nanotube (SWCNT), a multi-walled carbon nanotube (MWCNT), etc., and/or a metal-based material such as tin, tin oxide, titanium oxide, a perovskite material such as LaSrCoO₃ or LaSrMnO₃, etc.

In some embodiments, an electrode density of the cathode 100 may be in a range from 3.0 g/cc to 3.9 g/cc, for example, from 3.2 g/cc to 3.8 g/cc.

The anode 130 may include an anode current collector 125 and an anode active material layer 120 formed on at least one surface of the anode current collector 125. In exemplary embodiments, the anode active material layer 120 may be formed on both surfaces (e.g., upper and lower surfaces) of the anode current collector 125.

The anode active material layer 120 may be coated on each of the upper and lower surfaces of the anode current collector 125. For example, the anode active material layer 120 may directly contact the surface of the anode current collector 125.

In some embodiments of the disclosed technology, the anode current collector 125 may include gold, stainless steel, nickel, aluminum, titanium, copper, or an alloy of two or more of gold, stainless steel, nickel, aluminum, titanium, copper. In one example, the anode current collector 125 may include copper or a copper alloy.

In exemplary embodiments, the anode active material layer 120 may include the anode active material according to the above-described exemplary embodiments. For example, the anode active material may be included in an amount ranging from 80 wt % to 99 wt % based on a total weight of the anode active material layer 120. In some embodiments of the disclosed technology, the amount of the anode active material may be in a range from 90 wt % to 98 wt % based on the total weight of the anode active material layer 120.

For example, an anode slurry may be prepared by mixing and stirring the anode active material with a binder, a conductive material and/or a dispersive agent in a solvent. The anode slurry may be applied (coated) on the anode current collector 125, and then dried and pressed to form the anode active material layer 120.

The binder and the conductive material substantially the same as or similar to those used for forming the cathode 100 may be used in the anode 130. In some embodiments, the binder for forming the anode 130 may include, e.g., styrene-butadiene rubber (SBR) or an acrylic binder for compatibility with the graphite-based active material, and carboxymethyl cellulose (CMC) may also be used as a thickener.

In exemplary embodiments, the anode active material layer 120 may include a multi-layered structure including two or more layers. For example, the anode active material layer 120 may include a first anode active material layer 121 formed on the anode current collector 125 and a second anode active material layer 122 formed on the first anode active material layer 121.

In some embodiments, a content of the silicon-based active material included in the first anode active material layer 121 may be 6 wt % or less based on the total weight of the first anode active material layer 121. In some embodiments of the disclosed technology, the first anode active material layer 121 may include more than 0 wt % and 5 wt % or less of the silicon-based active material based on the total weight of the first anode active material layer 121.

In some embodiments, a content of the first carbon-based active material included in the first anode active material layer 121 may be less than 2 wt % based on the total weight of the first anode active material layer 121. In some embodiments of the disclosed technology, the first anode active material layer 121 may include more than 0 wt % and 1 wt % or less of the first carbon-based active material based on the total weight of the first anode active material layer 121.

For example, more than 0 wt % and 6 wt % or less of the silicon-based active material and more than 0 wt % and less than 2 wt % of the first carbon-based active material may be included based on a total solid content of the anode slurry forming the first anode active material layer 121.

In some embodiments, a content of the silicon-based active material included in the second anode active material layer 122 may be equal to or greater than 8 wt % and less than 40 wt % of a total weight of the second anode active material layer 122. In some embodiments of the disclosed technology, the second anode active material layer 122 may include the silicon-based active material in an amount from 15 wt % to 30 wt % based on the total weight of the second anode active material layer 122.

In some embodiments, a content of the first carbon-based active material included in the second anode active material layer 122 may be equal to or greater than 2 wt % and less than 4 wt % of the total weight of the second anode active material layer 122. In some embodiments of the disclosed technology, the second anode active material layer 122 may include the first carbon-based active material in an amount from 2 wt % to 3 wt % based on the total weight of the second anode active material layer 122.

For example, 8 wt % or more and less than 40 wt % of the silicon-based active material, and 2 wt % or more and less than 4 wt % of the first carbon-based active material may be included based on a total solid content of the anode slurry forming the second anode active material layer 122.

The first anode active material layer 121 and the second anode active material layer 122 have the above-described compositions and contents, so that the life-span properties of the secondary battery may be improved.

For example, the content of each of the silicon-based active material and the first carbon-based active material may be relatively greater in the second anode active material layer 122 than that in the first anode active material layer 121, so that the volume expansion of the anode active material layer 120 may be suppressed.

A relatively large amount of the first carbon-based active material capable of participating in the reaction at a low state of charge (SOC) region may be included in the second anode active material layer 122 having a relatively large content of the silicon-based active material, so that the volume expansion of the active material and the short circuit caused by the silicon-based active material may be effectively suppressed.

Additionally, the content of the first carbon-based active material may be greater in the second anode active material layer 122 that may be closer to the electrolyte, so that deterioration/regeneration of the SEI layer may be effectively prevented.

Further, penetration of the electrolyte and moisture to the first anode active material layer 121 may be suppressed by the second anode active material layer 122, so structural stability of the anode active material layer 120 may be improved.

Accordingly, it is possible to reduce resistance of the secondary battery while improving power performance, and mechanical/chemical damage may be prevented by the second anode active material layer 122. Thus, the life-span properties of the secondary battery may be improved.

In some embodiments, a content of the silicon-based active material based on a total weight of the anode active material included in the first anode active material layer 121 and the second anode active material layer 122 may be in a range from 5 wt % to 20 wt %, and the content of the first carbon-based active material may be in a range from 0.1 wt % to 2 wt %.

In some embodiments of the disclosed technology, the content of the silicon-based active material based on a total weight of the anode active material included in the first anode active material layer 121 and the second anode active material layer 122 may be in a range from 10 wt % to 15 wt %, and the content of the first carbon-based active material may be in a range from 1 wt % to 2 wt %.

In some embodiments, a ratio of a weight of the second anode active material layer 122 relative to a weight of the first anode active material layer 121 may be in a range from 1 to 4. Within the above range, the life-span properties and output performance of the secondary battery may be further improved.

In some embodiments, a thickness ratio of the first anode active material layer 121 and the second anode active material layer 122 may be in a range from 2:8 to 8:2. In one example, the thickness ratio of the first anode active material layer 121 and the second anode active material layer 122 may be in a range from 3:7 to 7:3. In another example, the thickness ratio of the first anode active material layer 121 and the second anode active material layer 122 may be in a range from 4:6 to 6:4.

In an embodiment, if the first anode active material layer 121 and the second anode active material layer 122 have the same thickness, an electrode density of the second anode active material layer 122 may be greater than that of the first anode active material layer 121.

In an embodiment, if the electrode densities of the first anode active material layer 121 and the second anode active material layer 122 are the same, the thickness of the second anode active material layer 122 may be greater than that of the first anode active material layer 121.

In some embodiments, the anode active material layer 120 may have a multi-layered structure including three or more layers, and each of the layers may have a different composition and content from those of other adjacent layers.

In this case, amounts of the silicon-based active material and the first carbon-based active material may become smaller in a region adjacent to the anode current collector 125. For example, the anode active material layer 120 may have a gradient structure in which the contents of the silicon-based active material and the first carbon-based active material increases as a distance from one surface of the anode current collector 125 increases. In this case, expansion/contraction of the anode active material layer 120 may be prevented, high-temperature storage and life-span properties may be improved while maintaining the power of the secondary battery.

In exemplary embodiments, an electrode density of the anode active material layer 120 may be 1.4 g/cc to 1.9 g/cc.

In some embodiments, an area and/or a volume of the anode 130 (e.g., a contact area with the separation layer 140) may be greater than that of the cathode 100. Thus, lithium ions generated from the cathode 100 may be easily transferred to the anode 130 without a loss by, e.g., precipitation or sedimentation to further improve power and capacity of the secondary battery.

The separation layer 140 may be interposed between the cathode 100 and the anode 130. The separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or others. The separation layer 140 may also include a non-woven fabric formed from a glass fiber with a high melting point, a polyethylene terephthalate fiber, or others.

The separation 140 may extend in a width direction of the secondary battery between the cathode 100 and the anode 130, and may be folded along the thickness direction of the lithium secondary battery. Accordingly, a plurality of the anodes 100 and the cathodes 130 may be stacked in the thickness direction using the separation layer 140.

In exemplary embodiments, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by laminating or folding the separation layer 140.

The electrode assembly 150 may be accommodated together with an electrolyte in the case 160 to define the lithium secondary battery. The case 160 may include, e.g., a pouch, a can, etc.

In exemplary embodiments, a non-aqueous electrolyte may be used as the electrolyte.

The non-aqueous electrolyte solution may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂—, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)_{3C}⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxy ethane, diethoxy ethane, vinylene carbonate, sulfolane, gamma-butyrolactone, propylene sulfite, tetrahydrofuran, or a combination of two or more of these materials.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

FIG. 1 illustrates that the cathode lead 107 and the anode lead 127 are positioned at the same side of the lithium secondary battery or the case 160, but the cathode lead 107 and the anode lead 127 may be formed at opposite sides to each other.

For example, the cathode lead 107 may be formed at one side of the case 160, and the anode lead 127 may be formed at the other side of the case 160.

The lithium secondary battery may be manufactured in, e.g., a cylindrical shape using a can, a square shape, a pouch shape or a coin shape.

Hereinafter, preferred embodiments are proposed to more concretely describe the disclosed technology. However, the following examples are only given for illustrating the disclosed technology and those skilled in the related art will obviously understand that various alterations and modifications are possible within the scope and spirit of the disclosed technology. Such alterations and modifications are duly included in the appended claims.

### Examples and Comparative Examples

(1) Fabrication of a Secondary Battery Having a Single-Layered Anode Active Material Layer

An anode active material was prepared by mixing a silicon-based active material, a first carbon-based active material and a second carbon-based active material in compositions and contents of Table 1. Hard carbon was used as the first carbon-based active material, and artificial graphite was used as the second carbon-based active material. The anode active material, SWCNT, CMC and SBR were mixed in a weight ratio of 97.2:0.1:1.2:1.5 to prepare an anode slurry. The anode slurry was coated on a Cu foil, dried and pressed to prepare an anode having a loading level per unit area of 10 mg/cm² and a mixture density of 1.7 g/cc.

In Example 6, as the content of the silicon-based active material was small, the loading level per unit area was adjusted to 12 mg/cm². In Example 7, as the content of the silicon-based active material was large, the loading level per unit area was adjusted to 8.0 mg/cm².

A cathode slurry was prepared by mixing LiNi_{0.8}Co_{0.1}Mn_{0.1}O₂ as a cathode active material, carbon black as a conductive material and polyvinylidene fluoride (PVDF) as a binder in a weight ratio of 92:5:3. The cathode slurry was coated on an aluminum substrate, dried and pressed to prepare a cathode.

The prepared cathode and anode were disposed with a polyethylene (PE) separator (13 μm) interposed therebetween to form an electrode cell, and the electrode cells were stacked to form an electrode assembly. The electrode assembly was accommodated in a pouch and electrode tab portions were fused. Thereafter, an electrolyte of 1M LiPF₆ solution in a mixed solvent of ethylene carbonate/ethylmethyl carbonate (EC/EMC, 3/7; volume ratio) was injected and then sealed to prepare a secondary battery.

TABLE 1

| | | | | | | | | | second | |
|---|---|---|---|---|---|---|---|---|---|---|
| | silicon-based | | | | | | | | carbon-based | |
| | active material | | | first carbon-based material | | | | | active material | |
| No. (wt %) | A-1 | A-2 | A-3 | B-1 | B-2 | B-3 | B-4 | B-5 | C-1 | C-2 |
| Example 1 | 13 | | | 2 | | | | | 85 | |
| Example 2 | 13 | | | | 2 | | | | 85 | |
| Example 3 | 13 | | | | 2 | | | | | 85 |
| Example 4 | | 13 | | 2 | | | | | 85 | |
| Example 5 | | 13 | | | 2 | | | | 85 | |
| Example 6 | 3 | | | | 2 | | | | 95 | |
| Example 7 | 25 | | | | 2 | | | | 73 | |
| Example 8 | 13 | | | | 0.05 | | | | 86.95 | |
| Example 9 | 13 | | | | 4 | | | | 83 | |
| Example 10 | 13 | | | | | | | 2 | 85 | |
| Example 11 | | 13 | | | | | | 2 | 85 | |
| Comparative | | | 13 | 2 | | | | | 85 | |
| Example 1 | | | | | | | | | | |
| Comparative | | | 13 | | 2 | | | | 85 | |
| Example 2 | | | | | | | | | | |
| Comparative | 13 | | | | | | | | 87 | |
| Example 3 | | | | | | | | | | |
| Comparative | 13 | | | | | 2 | | | 85 | |
| Example 4 | | | | | | | | | | |
| Comparative | 13 | | | | | | 2 | | 85 | |
| Example 5 | | | | | | | | | | |

A-1: SiOx (BET: 3.8 m²/g, true density: 2.2 g/cc)
A-2: SiOx (BET: 0.5 m²/g, true density: 2.5 g/cc)
A-3: SiOx (BET: 6.7 m²/g, true density: 1.8 g/cc)
B-1: first carbon-based active material (D50: 2 μm, I(110)/I(004): 0.05, Lc: 1 nm)
B-2: first carbon-based active material (D50: 4 μm, I(110)/I(004): 0.09, Lc: 5 nm)
B-3: first carbon-based active material (D50: 8 μm, I(110)/I(004): 0.05, Lc: 3 nm)
B-4: first carbon-based active material (D50: 8 μm, I(110)/I(004): 0.20, Lc: 36 nm)
B-5: first carbon-based active material (D50: 4 μm, I(110)/I(004): 0.20, Lc: 34 nm)
C-1: second carbon-based active material (D50: 15 μm)
C-2: second carbon-based active material (D50: 25 μm)

(2) Fabrication of a Secondary Battery Having a Multi-Layered Anode Active Material Layer

Anode active materials for the formation of a first anode active material layer and a second anode active material layer were mixed with compositions and contents as shown in Table 2 below. Each anode active material was mixed with SWCNT, CMC, and SBR in a weight ratio of 97.2:0.1:1.2:1.5 to prepare an anode slurry.

The first anode slurry used for the first anode active material layer was uniformly coated on a Cu foil. Subsequently, the second anode slurry used for the second anode active material layer was coated on the coated first anode slurry.

After coating the first anode slurry and the second anode slurry, drying and pressing were performed to prepare an anode (1.7 g/cc) including the first anode active material layer and the second anode active material layer.

A weight ratio of the first anode active material layer and the second anode active material layer was adjusted so that a content of the silicon-based active material included in the entire anode active material layer became 13 wt % based on a total weight of the anode active material.

Thereafter, a secondary battery was manufactured by the same method as that described in the above section (1).

TABLE 2

| | first anode active | | | second anode active | | |
|---|---|---|---|---|---|---|
| | material layer | | | material layer | | |
| No. (wt %) | A-1 | B-2 | C-1 | A-1 | B-2 | C-1 |
| Example 12 | 6 | 0.95 | 93.05 | 16 | 2.4 | 81.6 |
| Example 13 | 6 | 2.4 | 91.6 | 16 | 0.95 | 83.05 |
| Example 14 | 16 | 2.4 | 81.6 | 6 | 0.95 | 93.05 |
| Example 15 | 16 | 0.95 | 83.05 | 6 | 2.4 | 91.06 |
| Comparative | 6 | — | 94 | 16 | — | 84 |
| Example 6 | | | | | | |
| Comparative | 16 | — | 84 | 6 | — | 94 |
| Example 7 | | | | | | |

### Experimental Example

(1) Measurement of Initial Resistance

Charging (CC/CV, 0.3C rate, upper limit voltage 4.2V, cut-off current 0.05C) and discharging (CC, 0.3C, lower limit voltage 2.5V cut-off) were performed twice at 25° C. for the secondary batteries according to Examples and Comparative Examples). Thereafter, after charging to the upper limit voltage at a rate of 0.3C, discharging was performed to SOC50%. A resistance for 10 seconds of discharging at S0050% was measured (CC: Constant Current, CV: Constant Voltage).

(2) Evaluation on Life-Span Property

Life-span property evaluation for the secondary batteries of Examples and Comparative Examples was performed in a range of DOD94 (SOC2% to SOC96%) in a chamber maintained at 25° C.

Specifically, charging to a voltage corresponding to SOC96% (CC/CV, 0.3C rate, cut-off current 0.05C) and discharging (CC, 0.5C, cut-off) to a voltage corresponding to SOC2% was performed as one cycle. The charging/discharging was repeatedly performed at 10-minute intervals. A discharge capacity at the first cycle was measured, and a discharge capacity measured at the 300th cycles was measured as a ratio (%) relative to the discharge capacity at the first cycle.

(3) Evaluation on High Temperature Storage Properties

Charging (CC/CV method, 0.3C rate, upper limit voltage 4.2V, cut-off current 0.05C) and discharging (CC, 0.3C, lower limit voltage 2.5V cut-off) were performed once for the secondary batteries of Examples and Comparative Examples, and a discharge capacity was measured. Thereafter, charging to 4.2V (0.3C, cut-off current 0.05C) and discharging to a voltage corresponding to SOC96% were performed, and then stored in an oven at 60° C. for 12 weeks, and the charging and discharging was further performed once under the same conditions to measure a discharge capacity. The discharge capacity after the high-temperature storage was expressed as a ratio relative to the initial discharge capacity.

The evaluation results are shown in Tables 3 and 4 below.

TABLE 3

| | | life-span | high |
|---|---|---|---|
| | initial | property | temperature |
| | resistance | @300 cycle | storage |
| No. | (mOhm) | (%) | (60° C.) |
| Example 1 | 1.29 | 89.8 | 91.2 |
| Example 2 | 1.29 | 89.7 | 91.0 |
| Example 3 | 1.33 | 87.3 | 90.4 |
| Example 4 | 1.26 | 86.9 | 88.5 |
| Example 5 | 1.26 | 86.4 | 88.1 |
| Example 6 | 1.45 | 82.1 | 92.1 |
| Example 7 | 1.41 | 81.2 | 82.8 |
| Example 8 | 1.32 | 87.4 | 90.6 |
| Example 9 | 1.28 | 89.3 | 87.1 |
| Example 10 | 1.32 | 87.9 | 90.8 |
| Example 11 | 1.30 | 85.2 | 88.3 |
| Comparative | 1.32 | 86.1 | 85.7 |
| Example 1 | | | |
| Comparative | 1.32 | 86.3 | 85.9 |
| Example 2 | | | |
| Comparative | 1.34 | 87.2 | 90.8 |
| Example 3 | | | |
| Comparative | 1.31 | 85.8 | 86.1 |
| Example 4 | | | |
| Comparative | 1.31 | 84.9 | 85.4 |
| Example 5 | | | |

Referring to Tables 1 and 3, in Examples where the average particle diameter (D50) of the first carbon-based active material was in a range from 1 μm to 4 μm, initial resistance and life-span properties of the battery were improved.

Further, when a specific surface area of the silicon-based active material was adjusted to less than 5 m²/g, the energy density of the battery was improved and the resistance was decreased.

In Example 6, the loading level per unit area increased as the content of the silicon-based active material decreased, and the resistance and life-span properties were relatively degraded.

In Example 7, as the content of the silicon-based active material increased, the side reaction between the electrolyte and the silicon-based active material was increased, and the life-span and high temperature properties were relatively decreased due to an electrode swelling caused by a volume change of the silicon-based active material.

In Example 9, as the hard carbon content increased, the high temperature storage property was relatively decreased.

In Comparative Examples, as the average particle diameter of the first carbon-based active material or the BET surface area of the silicon-based active material were not within the ranges of the above-described exemplary embodiments, the life-span property, the resistance and the high temperature storage property were entirely deteriorated.

TABLE 4

| | | life-span | high |
|---|---|---|---|
| | initial | property | temperature |
| | resistance | @300 cycle | storage |
| No. | (mOhm) | (%) | (60° C.) |
| Example 12 | 1.21 | 92.1 | 93.7 |
| Example 13 | 1.23 | 90.3 | 94.1 |
| Example 14 | 1.33 | 89.2 | 94.0 |
| Example 15 | 1.32 | 88.8 | 93.9 |
| Comparative | 1.28 | 89.0 | 93.8 |
| Example 6 | | | |
| Comparative | 1.35 | 87.9 | 93.8 |
| Example 7 | | | |

Referring to Tables 2 and 4, in Examples including the first carbon-based active material, the initial resistance, the life-span property and the high temperature capacity retention were entirely improved compared to those from Comparative Examples.

In Example 12, as relatively large amounts of the silicon-based active material and the first carbon-based active material were included in the second anode active material layer (an upper layer) compared to those of the first anode active material layer (a lower layer), the life-span property of the secondary battery were further improved.

In Example 13 where a relatively small amount of the first carbon-based active material was included in the second anode active material layer, the initial resistance and the high-temperature storage property were similar to those of Example 12, and the life-span property was relatively decreased due to degradation of the silicon-based active material.

In Example 14 where a relatively small amount of the silicon-based active material was included in the second anode active material layer, the resistance and the life-span properties were relatively lowered due to a poor contact between the anode active material layer and the current collector caused by a volume expansion of the silicon-based active material included in the first anode active material layer.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

What is claimed is:

1. An anode for a secondary battery comprising an anode active material, wherein the anode active material comprises:
a silicon-based active material having a specific surface area in a range from 0.5 m²/g to 5 m²/g;
a first carbon-based active material having an average particle diameter (D50) in a range from 1 μm to 4 μm; and
a second carbon-based active material having an average particle diameter (D50) greater than the average particle diameter (D50) of the first carbon-based active material.

2. The anode of claim 1, wherein an average particle diameter of the second carbon-based active material is in a range from 8 μm to 20 μm.

3. The anode of claim 1, wherein I(110)/I(002) of the first carbon-based active material measured by an X-ray diffraction analysis (XRD) is in a range from 0.04 to 0.10, wherein I(110)/I(002) indicates a ratio of peak intensity of (110) plane and (002) plane of the first carbon-including active material obtained by X-ray diffraction.

4. The anode of claim 1, wherein a crystallite size (Lc) in a C-axis direction of the first carbon-based active material measured by an X-ray diffraction analysis (XRD) is less than 30 nm.

5. The anode of claim 1, wherein the first carbon-based active material comprises hard carbon.

6. The anode of claim 1, wherein the second carbon-based active material comprises natural graphite, artificial graphite or a mixture of the natural graphite and the artificial graphite.

7. The anode of claim 1, wherein the silicon-based active material comprises SiOx, wherein x is greater than zero and less than two.

8. The anode of claim 1, wherein the silicon-based active material has a true density in a range from 2.0 g/cc to 2.6 g/cc.

9. The anode of claim 1, wherein a content of the first carbon-based active material is in a range from 0.1 wt % to 2 wt % based on a total weight of the anode active material.

10. The anode of claim 1, wherein a content of the silicon-based active material is in a range from 5 wt % to 20 wt % based on a total weight of the anode active material.

11. The anode of claim 1, comprising an anode electrode current collector, and an anode active material layer comprising the anode active material,
wherein the anode active material layer comprises a first anode active material layer formed on the anode current collector, and a second anode active material layer formed on the first anode active material layer.

12. The anode of claim 11, wherein a content of the silicon-based active material included in the first anode active material layer is in 6 wt % or less based on a total weight of the first anode active material layer, and
a content of the silicon-based active material included in the second anode active material layer is equal to or greater than 8 wt % and less than 40 wt % based on a total weight of the second anode active material layer.

13. The anode of claim 12, wherein a content of the first carbon-based active material included in the first anode active material layer is less than 2 wt % based on the total weight of the first anode active material layer, and
a content of the first carbon-based active material included in the second anode active material layer is equal to or greater than 2 wt % and less than 4 wt % based on the total weight of the second anode active material layer.

14. The anode of claim 11, wherein a ratio of a weight of the second anode active material layer relative to a weight of the first anode active material layer is in a range from 1 to 4.

15. A secondary battery, comprising:
an anode including an anode active material, wherein the anode active material includes:
a silicon-based active material having a specific surface area in a range from 0.5 m²/g to 5 m²/g;
a first carbon-based active material an average particle diameter (D50) in a range from 1 μm to 4 μm; and
a second carbon-based active material having an average particle diameter (D50) greater than that the average particle diameter (D50) of the first carbon-based active material; and
a cathode facing the anode.

16. The secondary battery of claim 15, wherein an average particle diameter (D50) of the second carbon-based active material is in a range from 8 μm to 20 μm.

17. The secondary battery of claim 15, wherein the first carbon-based active material comprises hard carbon.

18. The secondary battery of claim 15, wherein the second carbon-based active material comprises natural graphite, artificial graphite or a mixture of the natural graphite and the artificial graphite.

19. The secondary battery of claim 15, wherein the silicon-based active material comprises SiOx, wherein x is greater than zero and less than two.

20. The secondary battery of claim 15, comprising an anode electrode current collector, and an anode active material layer comprising the anode active material,
wherein the anode active material layer comprises a first anode active material layer formed on the anode current collector, and a second anode active material layer formed on the first anode active material layer.
